(19) United States
(12) Patent Application Publication
(10) Pub. No.: US 2011/0173299 A1
(43) Pub. Date: Jul. 14, 2011

(54) WEBSITE-BASED NETWORK FILE EXPLORER

(76) Inventors: Simon Samuel Lightstone, Thornhill (CA); Aaron Samuel Mirsky, Jerusalem (IL)

(21) Appl. No.: 12/838,799

(22) Filed: Jul. 19, 2010

Related U.S. Application Data
(60) Provisional application No. 61/226,731, filed on Jul. 19, 2009.

(51) Int. Cl. G06F 17/30; G06F 15/16

(52) U.S. Cl. 709/219; 707/634; 707/E17.005

(57) ABSTRACT

There is provided a method and system for a web browser based file storage and retrieval. Data files may be stored for retrieval to a data store of a web server providing a web page-based interface for accessing the data store. Web pages presented via the web browser application may comprise a list of data files accessible for retrieval. A selected data file of the list is downloaded and a client application invoked for execution by the computer for interacting with the selected data file. The selected data file is automatically monitored for changes; and at least a changed portion of the selected data file uploaded in response to the monitoring. A context menu of options for respective data files may be provided to assist with file retrieval, for example, to direct the invocation of a client application with the downloaded data file.

### CROSS REFERENCE

This application claims the benefit of U.S. Provisional Application No. 61/226,731, filed Jul. 19, 2009 and incorporated herein by reference.

### FIELD

The present invention relates generally to computer interaction with remotely stored data files via a web-browser and more particularly to a file storage and retrieval system providing a website-based network file explorer for interacting with such data files.

### BACKGROUND OF THE INVENTION

Computers are often useful to view, edit and/or store information in data files. Computers may be configured with one or more applications to assist with such tasks. Some such applications may be adapted for word processing, drawing processing, video processing, image processing, spreadsheet processing, computer language programming, slide show presentations, etc. among others. Data files for such applications may be stored locally to a computer or remotely, e.g. to a store coupled to the computer via a network, whereby the computer accesses (i.e. stores and/or retrieves) the data files via a file storage and retrieval system. Also known are web browser applications (e.g. FireFox™, Chrome™, Internet Explorer™) for browsing web sites via web pages in accordance with one or more standards or protocols such as HTML, HTTP and TCP/IP among others.

### SUMMARY

There is provided a method and system for web browser-based file storage and retrieval. Data files may be stored for retrieval to a data store of a web server providing a web page-based interface for accessing the data store. Web pages presented via the web browser of a computer may comprise a list of data files accessible for retrieval. Via the web browser, a selected data file of the list may be downloaded and a client application available to the computer may be invoked for interacting with the selected data file. The selected data file is automatically monitored for changes; and at least a changed portion of the selected data file uploaded in response to the monitoring. A context menu of options for respective data files may be provided to assist with file retrieval, for example, to direct the invocation of a client application with the downloaded data file.

In accordance with one method aspect of the invention, there is provided a method of file storage and retrieval for a computer executing a web browser application wherein data files are stored for retrieval to a data store of a web server providing a web page-based interface for accessing the data store, the method comprising: presenting via the web browser application a web page comprising a list of data files stored to the data store; downloading a selected data file of the list and invoking a client application for execution by the computer for interacting with the selected data file; automatically monitoring the selected data file for changes; and uploading at least a changed portion of the selected data file in response to said monitoring.

In accordance with another method aspect of the invention, there is provided a method of file storage and retrieval for a computer executing a web browser application, the method comprising: providing a web page-based interface for storing and retrieving data files to a data store of a web server, said interface providing at least one web page including a list of data files stored to the data store for requesting downloading by said computer; downloading to the computer a selected data file of the list, said computer configured to automatically invoke a client application for execution by the computer for interacting with the selected data file; and storing at least a changed portion of the selected data file uploaded by the computer in response to automatically monitoring the selected data file for changes.

In accordance with a further method aspect, there is provided a method of file retrieval for a computer executing a web browser application wherein data files are stored for retrieval to a data store of a web server providing a web page-based interface for accessing the data store. The method comprises: determining client data comprising an identification of client applications and file associations available for execution by the computer for interacting with data files; presenting via the web browser application a web page comprising a list of data files stored to the data store, said page further comprising instructions for providing a context menu of options for interacting with respective data files from the list, said context menu defined using said client data; receiving interaction with the web page, said interaction comprising an identification of a selected data file for retrieval; and downloading the selected data file of the list and invoking a client application for execution by the computer for interacting with the selected data file.

Computer, server, and computer programme products as well as further features will be apparent to those of ordinary skill in the art.

### BRIEF DESCRIPTION OF THE DRAWINGS

An embodiment of the invention will now be described by way of example only with reference to the following drawings in which:

FIG. 1 is a block diagram showing an example communication network wherein a computer is coupled via a public, wide area network to remotely stored data files via a website in accordance with an embodiment of the invention;

FIGS. 2A and 2B are a flowchart showing operations to initialize and configure the computer for interacting with the data files in accordance with an embodiment;

FIGS. 3A and 3B are a flowchart showing operations for interacting with data files in accordance with an embodiment;

FIGS. 4-9 are screen shots showing example user interface in accordance with operations of FIGS. 3A and 3B.

For convenience, like numerals in the description refer to like structures in the drawings.

### DETAILED DESCRIPTION

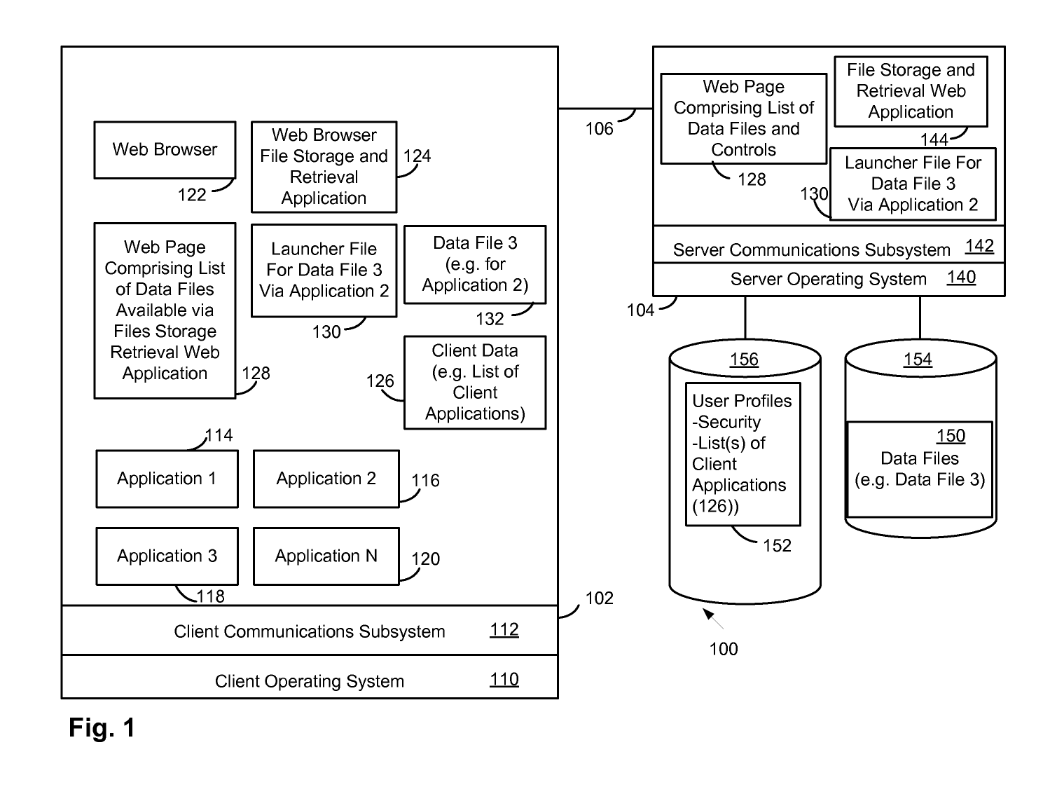

FIG. 1 is a block diagram showing an example and simplified communication network 100 wherein a computer 102 is coupled via a public, wide area network 106 to remotely stored data files 150 via a web server 104 providing a web site-based file storage and retrieval application (web-application) 144 in accordance with an embodiment of the invention.

Computer 102 may comprise a personal computer, workstation, laptop, PDA, smartphone or other device capable of communication with a web server. Details of such a computer are not shown. Typically such a computer comprises a programmable CPU (e.g. a microprocessor); memory or other storage devices (e.g. RAM, ROM, flash, optical or other disk storage, etc.) for storing instructions and data for configuring and operating the computer; and one or more input and/or output devices (e.g. keyboard, keys, buttons display screen (possibly a touch sensitive display screen providing I/O features), lights, speaker, microphone, pointing device, trackball, track wheel, track pad. Such devices also comprise one or more wired and/or wireless communication interfaces (e.g. USB, cellular, Bluetooth™, WiFi, WiMAX, etc.). Computer 102 in FIG. 1 represents a typical user or client computer configured in accordance with an embodiment of the present teachings and is schematically represented for simplicity showing computer program instructions and data defining one or more software components. Persons of skill in the art will appreciate that other representations and varied software components may be illustrated. It is also appreciated that more than one computer 102 may be coupled for communication with server 104.

Server 104 is similarly a simplified illustration of a web server environment. Not shown are various network components such as load balancing components, firewalls, routers, etc. Server 104 may comprise one or more computers. Server 104 in FIG. 1 is schematically represented for simplicity showing computer program instructions and data defining one or more software components in accordance with an embodiment of the present teachings. Persons of skill in the art will appreciate that other representations and varied software components may be illustrated.

Computer 102 is showing comprising an operating system 110 (e.g. Microsoft Windows™, Apple OS™, Linux™, etc.) a client communications subsystem 112 (e.g. for communicating via network 106 in a wired and/or wireless mode), various client applications 114, 116, 118 and 120 for example to view and/or edit applicable data files 150, a web browser 122 for interacting with web pages and other features of web server 104. Computer 102 also comprises a client-side web browser-based file storage and retrieval application for interacting with a server side file storage and retrieval application 144 as well as for interacting with components of computer 102 as described further below. In accordance with an embodiment computer 102 comprises client data 126 which may include a list of client applications (e.g. Application 1, 2, 3 . . . N and file associations) for use by application 124 and for providing to server 104 as described further. The web server may use the data to define the web page with components for the file storage and retrieval features, for example, to generate script or other instructions with which context menus may be generated during interaction with the web pages. A representative web page 128 is shown, received from server 104, and comprising a listing of data files 150 available via cooperating applications 124 and 144. Also shown is a launcher file 130 for a specific data file (Data File 3) to be opened using Application 2 (116) also as described further.

Server 104 comprises a server operating system 140, communication subsystem 142, a server side file storage and retrieval application for communicating with client-side applications (e.g. 124) and a launcher file for providing to a one of such applications for invoking (launching) a client side application (e.g. 114-120) with at least one of the data files 150. Server 104 may be coupled to one or more stores (e.g. databases) 154/156 for storing data files 150 and user profile data. Though shown as two separate stores, one or more than two such stores may be used.

User profile data may comprise security information (e.g. login information, file access or other permissions) and client data such as a list of applications 126 and file associations (not shown). A simplified user profile store is shown. For example, a list of client application related data may be stored and keyed (for lookup) in relation to specific computers 102 or instances of applications 124 as a specific user may interact with application 144 via more than one computer (e.g. home, office and handheld). As well, it may be contemplated that more than one user may interact with application 144 using the same computer 102 (though typically not simultaneously).

Server 104 and computer 102 may interact for web server services using known standards or protocols such as HTTP/HTTPS over TCP/IP. Browser 122 may communicate for web pages via such interface and request particular data files. Web pages (typically HTML-based) may provide various controls for use via browser 122. Illustrative controls may comprise a control to upload (i.e. save, or save new) a file to store 154, delete a file in store 154, rename a file, etc.

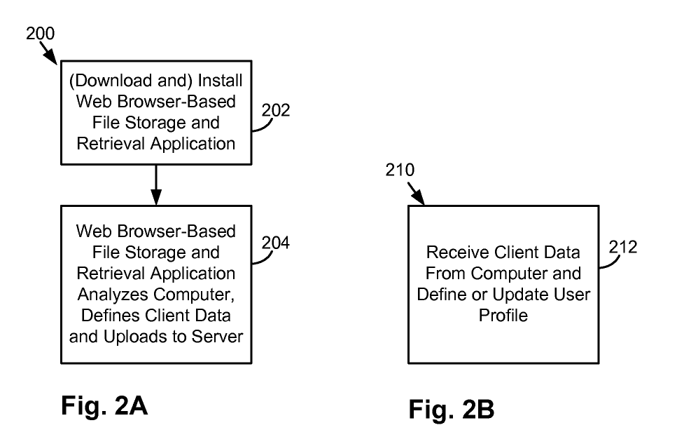

FIGS. 2A and 2B are flowcharts showing operations 200 and 210 to initialize and configure computer 102 for interacting with the data files 150 in accordance with an embodiment. At step 202, the client side application 124 is installed. It may be optionally downloaded or copied to computer 102 in other manners. It may be pre-installed (e.g. installed as a component of the operating system) or within the browser. At step 204 application 124 is invoked and it analyzes computer 102, for example, to compile list 126 for upload to server 104. Application 124 may also gather or determine and upload other data, for example, user security and preference or other data (e.g. to identify application 124, client local file or OS 110). In operations 210, server 104 receives the client data and defines a profile 152 (or updates a profile). The received data may include an identification of web browser file and storage retrieval application 124 installed at computer 102 as well as user data or data to identify the client OS 120, etc.

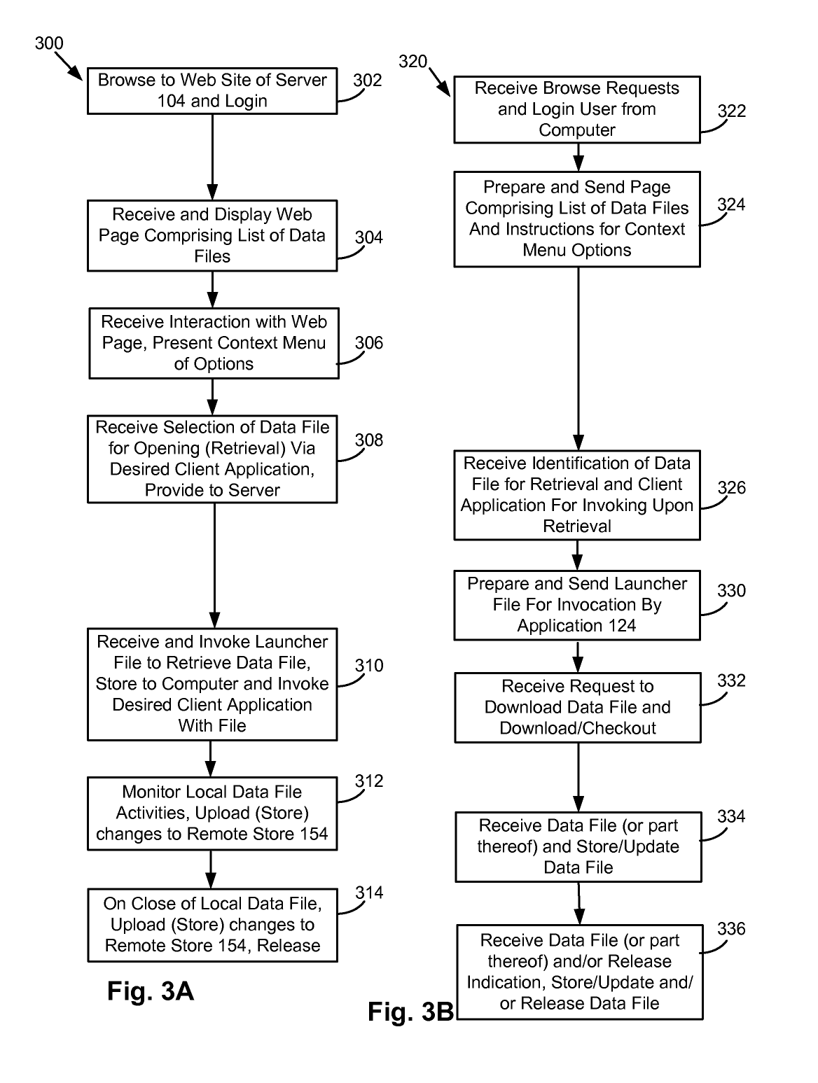

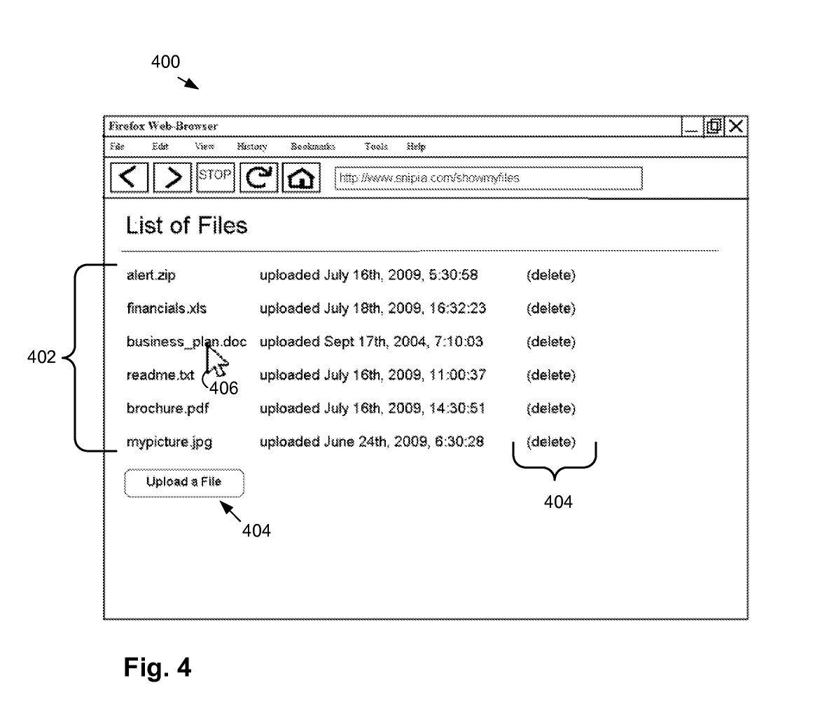

FIGS. 3A and 3B are flowcharts showing operations 300 and 320 for interacting with a data file from store 154 from the computer and server perspective respectively. FIGS. 4-9 are screen shots 400, 500, 600, 700, 800, 900 showing example user interface in accordance with operations of FIGS. 3A and 3B.

At steps 302, 322 browser 122 is directed to a web site of server 104 providing the file storage and service application 144. An authentication/user login is preferably undertaken. For example, using login data to identify a user profile 152, a web page (e.g. 128) is prepared and sent (step 324) to computer 102 comprising a list of data files 402 available to the particular user and one or more controls 404 for interacting with the files and/or data store 154. (See FIG. 4.) These controls may either overrule or extend the commonly found options provided by a web browser, to enable file interaction to be tailored to the specific data file and the user's computer environment and applications.

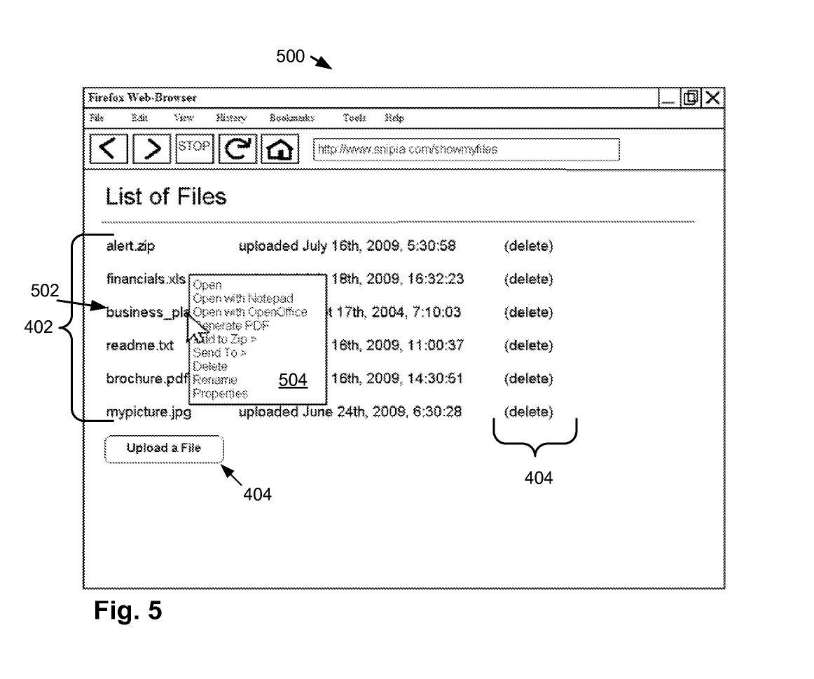

Received web page 128 configures operations of browser 122 and it is presented (e.g. displayed) via computer 102 (step 304). Browser 122 receives interaction (from the user (not shown) via computer input devices as represented by pointer 406) with the web page and its list of data files 402 (FIG. 5). A desired data file 502 may be selected to be retrieved (e.g. by moving a pointing device and “right clicking” in a Windows OS environment, or command click in Apple OS, etc.). A list of user options may be presented in a context menu 504 (e.g. in a pop up box). The context menu is preferably similar to a context menu that may be generated in a similar selection operation as if the selected data file was stored and available routinely to the file system and file handling features of the client operating system 102. For example, if the data file was stored (in a folder) locally to computer 102 or relatively remotely on a coupled drive (e.g. via an intranet connection, not shown) available to the operating systems file handling features.

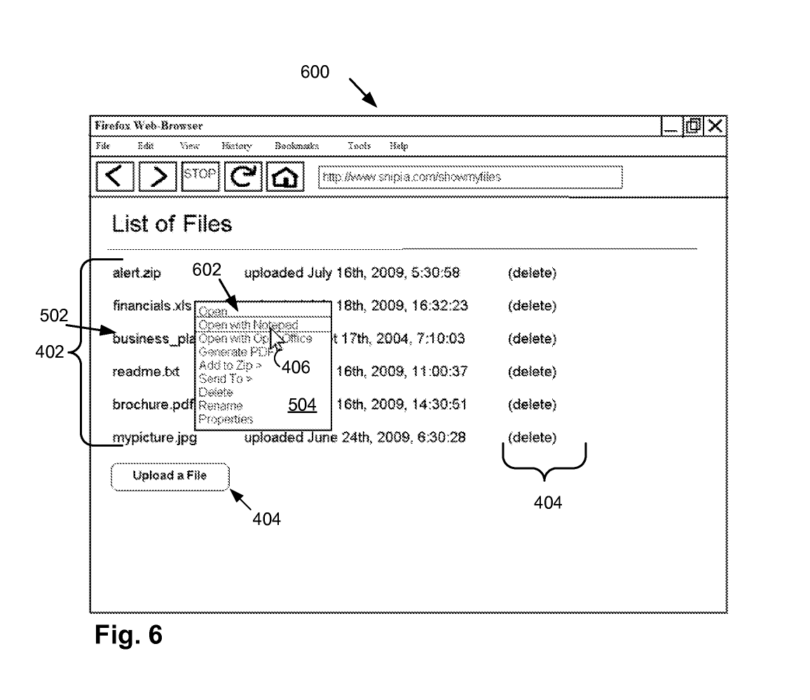

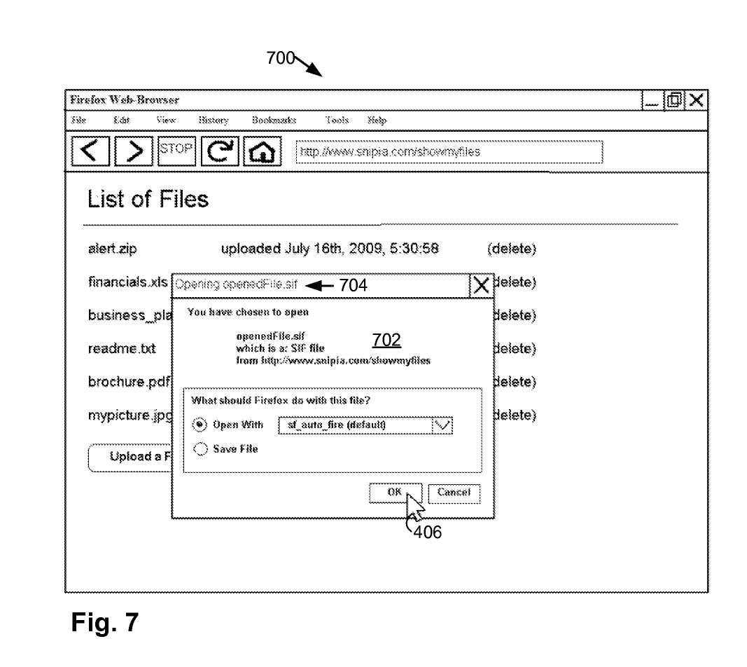

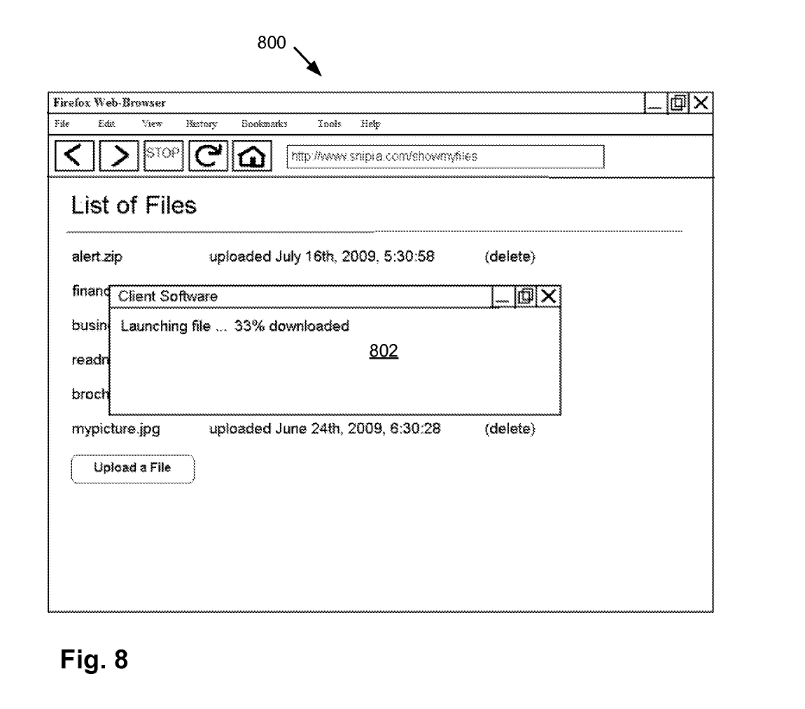

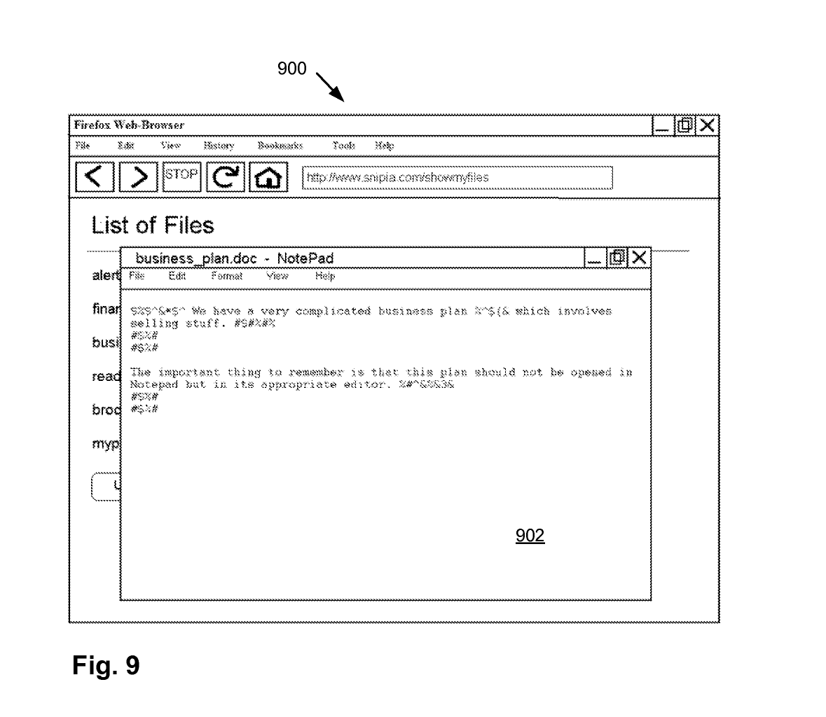

Context menu 504 provides user options to invoke actions such as “open”, “open with specific client applications” (114-120), including generate a portable document, “add to” archive, “send to” with options such as to a mail recipient or a store coupled to the computer, “delete”, “rename”, and “properties”. At Steps 308 and 326, input from the user identifies the action and data file, e.g. “open with client application 2” (See 602 of FIG. 6, where “Notepad” represents client application 2) and such is communicated to the server 104/application 144. A launcher file 130 may be prepared and sent (step 326) to download the data file and invoke client application 2 using the data file. The launcher file may be configured to invoke the client application in accordance with the configuration of the operating system 110 or applicable APIs. The launcher file 130 (e.g. “openedfil.sif” 704) is received (step 310) possibly occasioning a download dialog (702, FIG. 7) and invoked. The desired data file is downloaded (802, FIG. 8) and stored locally 132 (e.g. in a temporary store). Client application 2 (116) is invoked (902 FIG. 9) with the local data file in accordance with the operating system and client application (e.g. registered API, command interface, etc.) and usually within its own window. It may be noted that the need for a launcher file may be avoidable. For example, the information to launch a client application with a data file may be made available by a combination of client side storage and by being contained in the web page (e.g. via JavaScript).

When the data file is downloaded, server-side file storage and retrieval application 144 may check out or other wise identify the data file as being locked or used by a user in data store 154 such that if another user wishes to open the data file for editing, etc., version control and/or file integrity may be maintained. Optionally, for example, (not shown) the second user may open the locked file for viewing only.

At steps 312 334, client side file retrieval and storage application 124 monitors activity with the locally stored data file (e.g. by monitoring time stamps). Changes (i.e. file saves) by the local client application (e.g. 116) may be propagated (uploaded and stored) to the data store 154. At step 314, when the user finishes editing and closes the local data file 132 and/or exits application 116, application 124 may upload any final changes and communicate an indication that the selected data file may be released (step 336).

Within a web pages showing a list of data files available to download, JavaScript or other scripting may be employed to respond to the right-click events in the browser. The client-side application 124 may analyze (scan) the computer's operating system 110 settings for file associations to find the appropriate editor (client application), icons or other information. Such analysis may be performed when application 124 is installed or when application 124 is executed (such as in response to a file download) or even on regular intervals via a scheduler or “cron”. For a simple implementation to demonstrate this system on Windows XP, the Windows Explorer settings may be viewed in the following registry path for basic program associations: HKEY_CURRENT_USER \ Software \ Microsoft \ Windows \ CurrentVersion \ Explorer \ FileExts \.xls \ OpenWithList

As noted above, such settings (client data) may be saved for that user in the network data store (e.g. profiles 154) such as through an API on the web server. Application 144 on web server 104 can use this profile data to present the discussed file navigation interface. CGI language can be used to program the web server's behaviour.

The client-side application 124, when executing the launcher file 130, can use the corresponding settings (via list 126 or OS 110) and invoke the editor (116) with the downloaded file 132) as a command line parameter. Client-side application 124 then can monitor the edited data file 132 for changes. Changes to data in the data file may be inferred by monitoring modification times of the file for changes (as maintained by the file system features of OS 110 for example) or an OS file monitoring library (not shown) may be used for real-time file monitoring.

Though not shown, caching at computer 102 of data files remotely stored to store 154 may assist with operations and user experience. Cached copies may be used to avoid extra downloads. In some embodiments, only a part or parts of files which have changed may be downloaded (e.g. at steps 310, 332).

### Alternative Embodiments

One other issue with network file access is accessing files that are dependent on other files in the same folder, in sub-folders, or in other folders in general. However, in such circumstances, the launcher file may define the other files and/or directories for file access. Static files, on which the desired data file may be dependent, can be cached (e.g. to a local store of computer 102) in order to reduce the number of downloads.

In addition, when opening a file, a user can have the option of opening the file within the entire folder it is in. (In other words, the file, the folder it is in, and all sub-folders or other dependent folders are downloaded too.)

This system can even be used to browse files on the local computer, for example, using dynamically generated HTML based on the file system. One advantage is that this may allow the sharing of existing files on the computer 102 with others.

The client application 124 does not need to be created as a stand-alone program. It simply refers to the components. Some examples of the forms of these components could be part of the operating system or of a web browser.

It is interesting to note that with this system, if you have a good enough Internet/network connection, you can operate a computer with a minimal operating system. (One example would be an operating system contained completely on flash memory.)

The client applications need not be stored at the computer being used to retrieve and interact with the data files from the remote data store 154. The client applications are available to this computer, for example, from another user computer and/or server coupled thereto. The computer 102 may thus be a thin client or dumb terminal. Application 124 may be directed, for example through a user option, to gather and provide client data from one or more other or additional resources when compiling a list of client applications and file associations.

For mobile devices such as portable media players (e.g. iPod™) with Internet capabilities, the user does not have to store their media files on the iPod but can access the file via a network. They can navigate to the file listing and after “right clicking” they could select “send to iPod” or “stream to iPod”. Alternatively, a user could navigate to a playlist file and right-click to select “play playlist” therefore streaming and playing a whole collection of music files, which saves on the mobile device's storage space.

It's possible to avoid using a launcher file. There are many ways for the client software to get the information it needs about the file. Just one example is by polling the web server.

This could be turned into an effective blogging tool, since the user can open the file from the website and write the blog with the comfort of his/her local editor. Upon savings you could have a function that automatically puts the document's text up on the user's blog.

Client data provided to the web server (application 144) may comprise security related data such as login, file access permissions and specifics of the OS 110 such as an identification of the brand or type, (e.g. Windows™, Mac™, Linux™, etc.) and version information among others).

The methods and systems discussed herein may provide an easy way to edit computer files or other computer data through a regular website as if the files were on a local computer. Users may utilize the programs installed to (or available to) the local computer to edit the files, and can navigate the files in a similar way to how such users may do so in the local computer environment. However, the actual navigation and manipulation of files is done through a standards-based website. The methods and systems do not require additional drivers or significant integration into the operating system (just simple client software). In addition, because the interface is a website, the appearance of the navigation can be customized with the styles or appearance of the website.

In short, the teachings herein may provide an easy way to edit files located on a network or data cloud as if they were on a local computer with a minimal footprint on system resources. What the user experiences is a method of interaction that is already familiar to them from their use of local operating systems, but while being embedded inside a website. In turn the separation between the user's computer and the network/Internet becomes merged, closer to a single system.

Although specific embodiments of the invention have been described herein, it will be understood by those skilled in the art that variations may be made thereto without departing from the spirit of the invention or the scope of the appended claims.

1. A method of file storage and retrieval for a computer executing a web browser application wherein data files are stored for retrieval to a data store of a web server providing a web page-based interface for accessing the data store, the method comprising:
presenting via the web browser application a web page comprising a list of data files stored to the data store;
downloading a selected data file of the list and invoking a client application for execution by the computer for interacting with the selected data file;
automatically monitoring the selected data file for changes; and
uploading at least a changed portion of the selected data file in response to said monitoring.

2. The method of claim 1 comprising:
receiving interaction with the web page, said interaction comprising an identification of the selected data file for retrieval; and
communicating said identification to said web server to initiate said downloading.

3. The method of claim 2 comprising receiving from said web server launching instructions for execution by said computer to invoke the execution of the client application to open the downloaded selected data file.

4. The method of claim 3 wherein the interaction with the web page further comprises an identification of the client application to be invoked for opening the selected data file.

5. The method of claim 1 comprising determining client data comprising an identification of client applications and file associations available for execution by the computer for interacting with data files; and using said client data to provide via said web browser a context menu of options for interacting with respective data files of the list.

6. The method of claim 5 wherein the web page comprises instructions defined by said web server using said client data to provide a context menu in response to the client applications and file associations available for execution by the computer.

7. The method of claim 5 wherein the context menu of options is presented in response to an interaction with the selected data file as if the data file where maintained by a file system provided by an operating system of said computer.

8. The method of claim 5 comprising providing said client data to said web server for defining launching instructions for execution by said computer to invoke the execution of the client application to open the downloaded selected data file.

9. The method of claim 1 wherein the web page further comprises one or more controls selected from the group of controls for uploading a new data file to said data store, renaming a previously stored data file; and deleting a previously stored data file stored.

10. The method of claim 1 comprising providing authentication data to said web server to obtain access to said data store.

11. The method of claim 1 wherein the selected data file is locked in response to the downloading and wherein the method comprises communicating to said web server to release the selected data file in response to said monitoring.

12. A method of file storage and retrieval for a computer executing a web browser application, the method comprising:
providing a web page-based interface for storing and retrieving data files to a data store of a web server, said interface providing at least one web page including a list of data files stored to the data store for requesting downloading by said computer;
downloading to the computer a selected data file of the list, said computer configured to automatically invoke a client application for execution by the computer for interacting with the selected data file;
and storing at least a changed portion of the selected data file uploaded by the computer in response to automatically monitoring the selected data file for changes.

13. The method of claim 12 comprising receiving an identification of the selected data file from said computer to initiate said downloading.

14. The method of claim 13 comprising defining and communicating to said computer launching instructions for execution by said computer to invoke the execution of the client application to open the downloaded selected data file.

15. The method of claim 14 further comprising receiving an identification of the client application to be invoked for opening the selected data file.

16. The method of claim 1 comprising receiving and storing from said computer client data comprising an identification of client applications and file associations available for execution by the computer for interacting with data files.

17. The method of claim 16 comprising defining launching instructions using said client data for execution by said computer to invoke the execution of the client application to open the downloaded selected data file.

18. The method of claim 12 wherein the web page further comprises one or more controls selected from the group of controls for uploading a new data file to said data store, renaming a previously stored data file; and deleting a previously stored data file stored.

19. The method of claim 12 comprising receiving authentication data from said computer to provide access to said data store.

20. The method of claim 12 comprising locking the selected data file in response to the downloading and release the selected data file in response to a release communication from said computer.

21. A method of file retrieval for a computer executing a web browser application wherein data files are stored for retrieval to a data store of a web server providing a web page-based interface for accessing the data store, the method comprising:
determining client data comprising an identification of client applications and file associations available for execution by the computer for interacting with data files;
presenting via the web browser application a web page comprising a list of data files stored to the data store, said page further comprising instructions for providing a context menu of options for interacting with respective data files from the list, said context menu defined using said client data;
receiving interaction with the web page, said interaction comprising an identification of a selected data file for retrieval; and
downloading the selected data file of the list and invoking a client application for execution by the computer for interacting with the selected data file.

22. The method of claim 21 comprising communicating the client data to the web server for defining the instructions of the web page to provide the context menu.

23. The method of claim 21 comprising:
communicating said identification of the selected data file to said web server to initiate said downloading.

24. The method of claim 21 comprising receiving from said web server launching instructions for execution by said computer to invoke the execution of the client application to open the downloaded selected data file.

25. The method of claim 24 wherein the interaction with the web page further comprises an identification of the client application to be invoked for opening the selected data file.

26. The method of claim 21 wherein the context menu of options is presented in response to an interaction with the selected data file as if the data file where maintained by a file system provided by an operating system of said computer.

27. The method of claim 21 comprising providing said client data to said web server for defining launching instructions for execution by said computer to invoke the execution of the client application to open the downloaded selected data file.
